(19) United States
(12) Patent Application Publication
(10) Pub. No.: US 2026/0210749 A1
(43) Pub. Date: Jul. 23, 2026

(54) A Commodity Monitoring System and Related Methods

(71) Applicants: GSI Electronique Inc., St Hubert (CA); University of Manitoba, Winnipeg (CA)

(72) Inventors: Colin Gerald Gilmore, Winnipeg (CA); Joe Lovetri, Winipeg (CA); Ian Jeffrey, Winnipeg (CA); Kevin Brown, Winnipeg (CA); Mohammad Asefi, Winnipeg (CA); Hannah Claire Fogel, Winnipeg (CA); Samira Mohammadzamani, Winnipeg (CA)

(21) Appl. No.: 19/140,895

(22) PCT Filed: Oct. 12, 2023
(86) PCT No.: PCT/IB2023/060313

§ 371 Date: Jun. 18, 2025

Related U.S. Application Data
(60) Provisional application No. 63/476,231, filed on Dec. 20, 2022.

(51) Int. Cl. G01F 23/284; G06Q 50/02; H01Q 1/22

(52) U.S. Cl. CPC G01F 23/284; H01Q 1/225; G06Q 50/02

(57) ABSTRACT

A commodity monitoring system configured to receive measurement data from an antenna probe of an antenna array mounted within a container, compare the received measurement data to reference measurement data of a known state of the antenna probe of the antenna array, and based at least partially on the comparison, determine whether the antenna probe of the antenna array is in a commodity within the container or out of the commodity within the container. A method includes applying an energy to the commodity via at least one antenna probe, receiving remaining energy via at least one other antenna probe of the antenna array, based on the received remaining energy, determine measurement data; compare the determined measurement data to reference measurement data, and determine whether the given antenna probe of the antenna array is in the commodity within the container or out of the commodity within the container.

### FIELD

Embodiments of the present disclosure relate to imaging of contents within containers.

### BACKGROUND

Imaging contents (e.g., a commodity), such a grain, within a storage container (e.g., a silo) is a powerful tool for monitoring conditions of the commodity, especially when the interior of the container is relative difficult to access. For example, when monitoring grain within a storage bin, knowledge of the topography of a top surface of the grain enables a volume of grain in the storage bin to be determined. Knowing the volume of the grain is of economic importance to anyone storing grain in storage bins. Once grain volume is known, the weight of the grain within the storage bin can be calculated via conventional methods. Typically, grain is bought and sold by weight. Accordingly, accurate calculations of the weight of the grain within the storage bin are important to both the seller and buyer of the grain.

### BRIEF SUMMARY

Embodiments include a commodity monitoring system that includes at least one processor and at least one non-transitory computer-readable storage medium storing instructions thereon that, when executed by the at least one processor, cause the commodity monitoring system to receive measurement data from an antenna probe of an antenna array mounted within a container, compare the received measurement data to reference measurement data of a known state of the antenna probe of the antenna array, and based at least partially on the comparison, determine whether the antenna probe of the antenna array is in a commodity within the container or out of the commodity within the container.

The commodity monitoring system may also include instructions that when executed by the at least one processor, cause the commodity monitoring system to, based at least partially on the determination whether the antenna probe of the antenna array is in the commodity within the container or out of the commodity within the container, determine a height of the commodity against an inner surface of a wall of the container within a least one region of the container.

The commodity monitoring system may also include instructions that when executed by the at least one processor, cause the commodity monitoring system to receive measurement data from each antenna probe of the antenna array, compare the received measurement data of each antenna probe to reference measurement data of a known state of each antenna probe of the antenna array, and based at least partially on the comparisons, determine whether each antenna probe of the antenna array is in the commodity within the container or out of the commodity within the container.

The commodity monitoring system may also include instructions that when executed by the at least one processor, cause the commodity monitoring system to cause the antenna probe of the antenna array to apply an energy to the commodity within the container, and receive remaining energy that has passed through at least a portion of the commodity via at least one other antenna probe of the antenna array.

Comparing the received measurement data to the reference measurement data of a known state of the antenna probe of the antenna array may include comparing a first dip reflected in a plotted curve of the received measurement data across a range of frequencies to a correlating, second dip reflected in a plotted curve of the reference measurement data across the range of frequencies.

The reference measurement data of a known state of the antenna probe of the antenna array may reflect the antenna probe in commodity.

The reference measurement data of a known state of the antenna probe of the antenna array may reflect the antenna probe out of commodity.

The received measurement data may include a magnitude of a received RF signal.

The commodity monitoring system may also include instructions that when executed by the at least one processor, cause the commodity monitoring system to, based at least partially on the determinations whether each antenna probe of the antenna array is in the commodity within the container or out of the commodity within the container, determine heights of the commodity against the inner surface of the wall of the container within at least a plurality of regions of the container.

The commodity monitoring system may also include instructions that when executed by the at least one processor, cause the commodity monitoring system to estimate a profile of the height of the commodity against the inner surface of the wall of the container.

The commodity monitoring system may also include instructions that when executed by the at least one processor, cause the commodity monitoring system to provide the determined heights of the commodity against the inner surface of the wall of the container to a client device for display.

The commodity monitoring system may also include instructions that when executed by the at least one processor, cause the commodity monitoring system to determine the measurement data based at least partially on the received remaining energy.

Causing the antenna probe of the antenna array to apply an energy to the commodity within the container may include causing the antenna probe to apply RF signals to the commodity within the container.

Comparing the first dip to the correlating, second dip may include comparing a central frequency of the first dip to a central frequency of the correlating, second dip.

Embodiments include a method of monitoring a commodity within a container, the method may include applying an energy to the commodity within the container via at least one antenna probe of an antenna array mounted within the container, receiving remaining energy that has passed through at least a portion of the commodity or an interior of the container via at least one other antenna probe of the antenna array, based on the received remaining energy, determining measurement data, compare the determined measurement data to reference measurement data of a known state of a given antenna probe of the antenna array, and based at least partially on the comparison, determining whether the given antenna probe of the antenna array is in the commodity within the container or out of the commodity within the container.

The method may also include, based at least partially on the determination whether the given antenna probe of the antenna array is in the commodity within the container or out of the commodity within the container, determining a height of the commodity against an inner surface of a wall of the container within a least one region of the container.

Applying an energy to the commodity may include emitting electromagnetic energy into the commodity a set of discrete, sequential frequencies.

The method may also include estimating a profile of the height of the commodity against the inner surface of the wall of the container.

Comparing the determined measurement data to reference measurement data may include comparing a first dip reflected in a plotted curve of the received measurement data across a range of frequencies to a correlating, second dip reflected in a plotted curve of the reference measurement data across the range of frequencies.

Embodiments include a system having a container housing a commodity. The system also includes an antenna array having a plurality of antenna probes within the container. The system also includes an antenna controller operably coupled to and in communication with the antenna array. The system also includes a commodity monitoring system in communication with the antenna controller and including at least one processor and at least one non-transitory computer-readable storage medium storing instructions thereon that, when executed by the at least one processor, cause the commodity monitoring system to receive measurement data from the antenna array, compare the received measurement data to reference measurement data of known states of the plurality of antenna probes of the antenna array, and based at least partially on the comparison, determine whether a given antenna probe of the plurality of antenna probes of the antenna array is in the commodity within the container or out of the commodity within the container. Other technical features may be readily apparent to one skilled in the art from the following figures, descriptions, and claims.

Within the scope of this application it should be understood that the various aspects, embodiments, examples and alternatives set out herein, and individual features thereof may be taken independently or in any possible and compatible combination. Where features are described with reference to a single aspect or embodiment, it should be understood that such features are applicable to all aspects and embodiments unless otherwise stated or where such features are incompatible.

### BRIEF DESCRIPTION OF THE DRAWINGS

While the specification concludes with claims particularly pointing out and distinctly claiming what are regarded as embodiments of the present disclosure, various features and advantages may be more readily ascertained from the following description of example embodiments when read in conjunction with the accompanying drawings, in which:

FIG. 1 shows an environment within which a commodity monitoring system can operate according to one or more embodiments of the disclosure;

FIG. 2 shows a method of monitoring contents within a container according to one or more embodiments of the disclosure;

FIG. 3 shows a graph depicting determined measurement data and reference measurement data for a given antenna probe of an antenna array; and

FIG. 4 is a schematic view of a computer device according to embodiments of the disclosure.

### DETAILED DESCRIPTION

Illustrations presented herein are not meant to be actual views of any particular commodity monitoring system, container, antenna probe, antenna array, component, or system, but are merely idealized representations that are employed to describe embodiments of the disclosure. Additionally, elements common between figures may retain the same numerical designation for convenience and clarity.

The following description provides specific details of embodiments. However, a person of ordinary skill in the art will understand that the embodiments of the disclosure may be practiced without employing many such specific details. Indeed, the embodiments of the disclosure may be practiced in conjunction with conventional techniques employed in the industry. In addition, the description provided below does not include all the elements that form a complete structure or assembly. Only those process acts and structures necessary to understand the embodiments of the disclosure are described in detail below. Additional conventional acts and structures may be used. The drawings accompanying the application are for illustrative purposes only, and are thus not drawn to scale.

As used herein, the terms “comprising,” “including,” “containing,” “characterized by,” and grammatical equivalents thereof are inclusive or open-ended terms that do not exclude additional, unrecited elements or method steps, but also include the more restrictive terms “consisting of” and “consisting essentially of” and grammatical equivalents thereof.

As used herein, the singular forms following “a,” “an,” and “the” are intended to include the plural forms as well, unless the context clearly indicates otherwise.

As used herein, the term “may” with respect to a material, structure, feature, or method act indicates that such is contemplated for use in implementation of an embodiment of the disclosure, and such term is used in preference to the more restrictive term “is” so as to avoid any implication that other compatible materials, structures, features, and methods usable in combination therewith should or must be excluded.

As used herein, the term “configured” refers to a size, shape, material composition, and arrangement of one or more of at least one structure and at least one apparatus facilitating operation of one or more of the structure and the apparatus in a predetermined way.

As used herein, any relational term, such as “first,” “second,” “third,” etc. is used for clarity and convenience in understanding the disclosure and accompanying drawings, and does not connote or depend on any specific preference or order, except where the context clearly indicates otherwise.

As used herein, the term “substantially” in reference to a given parameter, property, or condition means and includes to a degree that one skilled in the art would understand that the given parameter, property, or condition is met with a small degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, the term “about” used in reference to a given parameter is inclusive of the stated value and has the meaning dictated by the context (e.g., it includes the degree of error associated with measurement of the given parameter, as well as variations resulting from manufacturing tolerances, etc.).

As used herein, the term “and/or” includes any and all combinations of one or more of the associated listed items.

As used here, the term “measurement” when used in reference to contents of (e.g., grain within) a container may refer to applying an energy (e.g., RF signals) to the contents of the container and receiving energy (e.g., remaining signals) that have passed through at least a portion of the contents (e.g., have been scattered by the contents). The received energy (e.g., signals) may constitute measurement data and/or data from which measurement data may be determined.

Embodiments include a commodity monitoring system that can utilize measurement data acquired via an antenna array to determine a height of a commodity (e.g., grain) against an inner surface of a wall of a storage container (e.g., a grain silo). In particular, by analyzing measurements acquired by an antenna array over time, a determination can be made as to when a given antenna probe of the antenna array is “in commodity” (e.g., within grain) and when the given antenna probe is “out of commodity” (e.g., out of grain). For example, shifts and changes of a profile of measured frequencies (e.g., a curve profile) for a given antenna probe can indicate whether a given antenna probe is in or out of commodity.

Furthermore, by determining, for each antenna probe of an antenna array, whether the given antenna probe is in or out of commodity, a profile of the commodity against the inner surface of the wall of the storage container can be estimated (e.g., extrapolated). Knowing the heights of the commodity against the inner surface of the wall of the storage container can yield more accurate data in regard to an amount of a commodity remaining within the storage container.

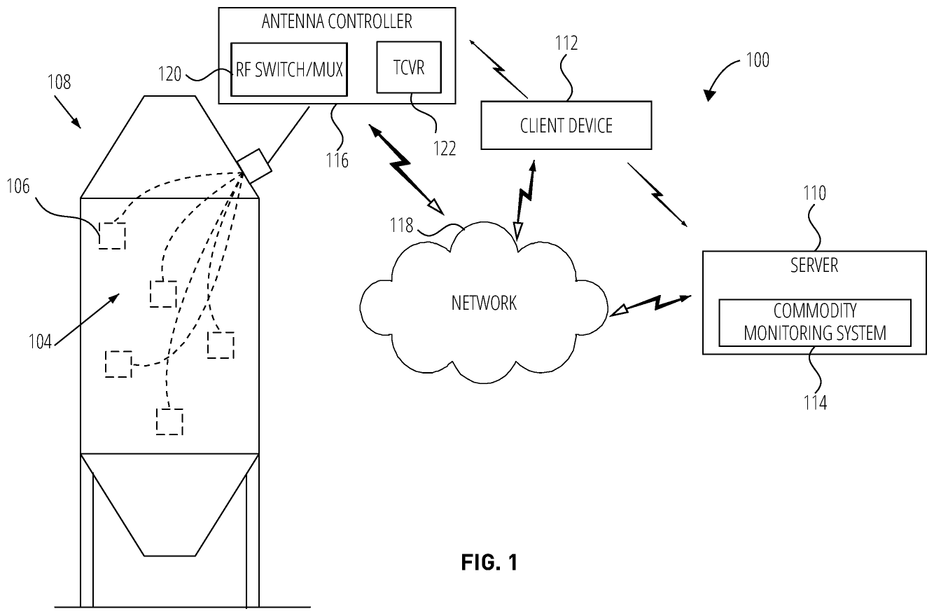

FIG. 1 is a schematic diagram of an environment 100 in which a commodity monitoring system 114 may operate according to one or more embodiments of the present disclosure. As shown in FIG. 1, the environment 100 may include an antenna array 104 having a plurality of antenna probes 106 coupled to an antenna controller 116, at least one client device 112, at least one server 110 including the commodity monitoring system 114, and a network 118. The commodity monitoring system 114, the client device 112, and the antenna controller 116 may communicate via the network 118. Although FIG. 1 illustrates a particular arrangement of the client device 112, the server 110, the antenna controller 116, and the network 118, various additional arrangements are possible. For example, the server 110 and, accordingly, the commodity monitoring system 114, can communicate directly with the client device 112 and/or the antenna controller 116, thereby bypassing the network 118.

As shown in FIG. 1, the plurality of antenna probes 106 of the antenna array 104 may be mounted (e.g., attached) to a wall (e.g., the inner surface of the wall) of a container 108 and may be utilized to monitor contents (e.g., a commodity) within the container 108. The plurality of antenna probes 106 of the antenna array 104 may be mounted to the inner surface of the wall of the container 108 in a manner such the plurality of antenna probes 106 at least substantially surround the contents within the container 108. Furthermore, the plurality of antenna probes 106 of the antenna array 104 may be mounted at varying known elevations (e.g, heights) within the container 108.

As is discussed in greater detail below, the plurality of antenna probes 106 are configured to inject signals/energy (e.g., pulses) into the contents within the container 108 and to receive (e.g., collect) resulting signals (e.g., scattered signals) that have passed through the contents. For example, each of the plurality of antenna probes 106 is polarized to provide excitement signals and collect resulting signals scattered by the contents. Furthermore, the plurality of antenna probes 106 may be utilized in electromagnetic imaging processes using at least some of the antenna probes 106 as active transmitters of electromagnetic radiation and at least some of the antenna probes 106 as receivers of electromagnetic radiation. In some embodiments, at least some of the antenna probes 106 may be utilized as both transmitters and receivers. Moreover, based on the transmitted and received electromagnetic radiation, quantitative and qualitative images of a dielectric profile of the contents of the container 108 may be generated. For example, the commodity monitoring system 114 may generate images of the contents of the container 108 via any of the manners described in U.S. Pat. No. 11,125,796 B2, to Gilmore et al., issued Sep. 21, 2021, WO 2021/001796 A1, to Jeffrey et al., filed Jul. 3, 2020, WO 2021/070101 A1, to Jeffrey et al., filed Oct. 8, 2020, WO 2022/200909 A1, to Asefi et al., filed Mar. 14, 2022, WO 2022/200931 A1, to Lovetri et al., filed Mar. 16, 2022, and/or WO 2022/200932 A1, to Asefi et al., filed Mar. 16, 2022.

The container 108 may include a grain storage bin. Furthermore, while a particular geometry is depicted in FIG. 1, it understood that the container 108 may include one or more containers of other geometries, for the same contents (e.g., grain) or other contents, with a different arrangement and/or quantity of inlet, outlet, and/or side ports.

The plurality of antenna probes 106 may be operably coupled to the antenna controller 116 via one or more cables (e.g., coaxial cables). The antenna controller 116 may include a vector network analyzer and may include one or more of a radio frequency (RF) switch matrix (e.g., an array of RF switches arranged to route RF signals between multiple inputs and multiple outputs) and/or an RF multiplexor (MUX) (referred to within FIG. 1 collectively as RF switch/MUX 120) for routing signals to and from the plurality of antenna probes 106. Additionally, the antenna controller 116 may include an electromagnetic transceiver 122 (TCVR 122). Accordingly, the RF switch/MUX 120 of the antenna controller 116 enables each of the antenna probe 106 to deliver RF energy and/or collect RF energy provided by other antenna probe 106 and scattered by the contents of the container 108. The TCVR 122 of the antenna controller 116 generates the RF signals (e.g., RF wave) for providing to the contents of the container 108 via the plurality of antenna probe 106 and receives the resulting RF signals measured (e.g., acquired) by the plurality of antenna probe 106. In view of the foregoing, the commodity monitoring system 114 may utilize the TCVR 122 and the RF switch/MUX 120of the antenna controller 116 and the antenna array 104 to interrogate the contents of the container 108 via RF signals.

In some embodiments, a user can interface with the client device 112, for example, to communicate with the server 110 and to utilize the commodity monitoring system 114 to monitor contents of the container 108. The user may include one or more operators of the container 108. Although FIG. 1 only shows a single client device 112, the environment 100 can include any number of client devices 112 in communication with the network 118, server 110, and/or antenna controller 116.

In some embodiments, the client device 112 may include a client application installed thereon. In one or more embodiments, the client application can be associated with the commodity monitoring system 114. For example, the client application may allow the client device 112 to directly or indirectly interface with the commodity monitoring system 114 of the server 110. The client application also enables a user (e.g., an operator) to initiate measurements via the commodity monitoring system 114 and observe any results of the measurements (e.g., generated images representing the contents of the container 108).

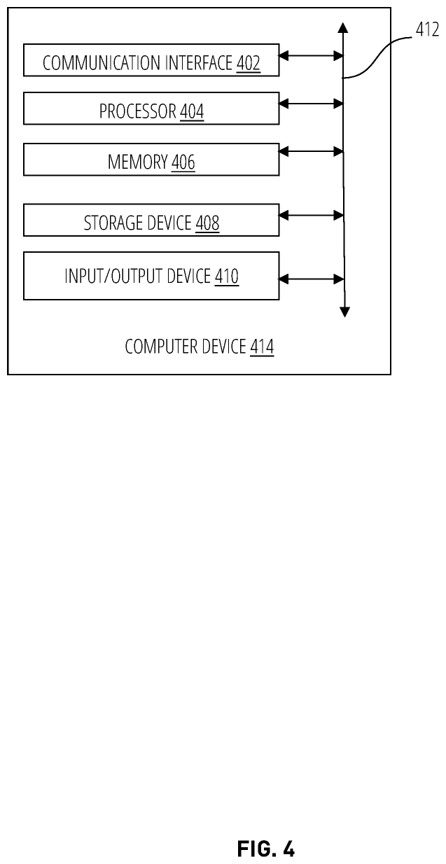

Both the client device 112 and the server 110 (and the commodity monitoring system 114) can represent various types of computing devices with which operators can interact. For example, the client device 112 and/or the server 110 may include a mobile device (e.g., a cell phone, a smartphone, a PDA, a tablet, a laptop, a watch, a wearable device, etc.). In some embodiments, however, the client device 112 and/or server 110 can be a non-mobile device (e.g., a desktop or server). In some embodiments, the server 110 may include a cloud computing platform and may be configured to perform processing required to implement the commodity monitoring system 114. In one or more embodiments, the server 110 may include a web server that provides a web site that can be used by operators monitoring the contents of the container 18 via a remote client device 112. Additional details with respect to the client device 112 and the server 110 are discussed below with respect to FIG. 4.

Referring still to FIG. 1, while the commodity monitoring system 114 is depicted as being a portion of (e.g., implemented by) the server 110, the disclosure is not so limited. Rather, in some embodiments, the commodity monitoring system 114 may be implemented at one or more of the client device 112, the antenna controller 116, or the server 110. In some embodiments, the commodity monitoring system 114 may be implemented at a computing device that is local to the container 108 (e.g., edge computing). In some embodiments, the commodity monitoring system 114 may be implemented at different devices of the environment 10 operating according to a primary-secondary configuration or peer-to-peer configuration. For purposes of illustration and convenience, implementation of the commodity monitoring system 114 is described herein as being implemented by the server 110, with the understanding that functionality may be implemented in other and/or additional devices.

The network 118 may include one or more networks, such as the Internet, and can use one or more communications platforms or technologies suitable for transmitting data and/or communication signals. As a non-limiting example, the network 118 may utilize one or more of near field communication (NFC), BLUETOOTH@, wireless/cellular networks, wide area networks (WAN), wired communications, or any other conventional network for transmitting data and/or communication signals between the antenna controller 116, client device 112, server 110, and commodity monitoring system 114.

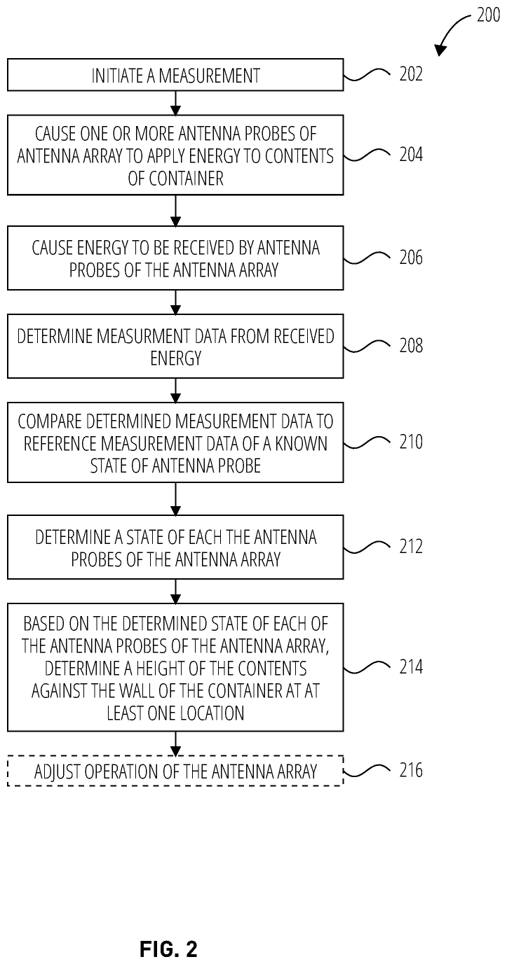

FIG. 2 shows a flowchart of a method 200 for monitoring the contents (e.g., grain) within a container 108 according to one or more embodiments of the present disclosure. The method 200 may include initiating a measurement of the contents of the container 108, as shown in act 202 of FIG. 2. In some embodiments, the commodity monitoring system 114 may initiate the measurement of the contents of the container 108.

In some embodiments, initiating the measurement of the contents of the container 108 may include initiating the measurement of the contents of the container 108 responsive to receiving a user input (e.g., an operator input) at one or more of the client device 112, the server 110, or the antenna array 104 to initiate a measurement. In additional embodiments, initiation of the measurement of the contents of the container 108 may occur automatically. For instance, measurements on the contents of the container 108 may occur according to a preselected schedule. In some embodiments, initiation of the measurement of the contents of the container 108 may occur responsive to contents being added to and/or removed from the container 108.

In one or more embodiments, initiating the measurement of the contents of the container 108 may include transmitting instructions to the antenna controller 116 to perform a measurement of the contents of the container 108. For instance, initiating the measurement of the contents of the container 108 may include transmitting instructions to the antenna controller 116 to activate one or more antenna probes 106 of the antenna array 104. The instructions may be transmitted through any of the networks 118 described herein.

Responsive to initiating the measurement of the contents of the container 108, the method 200 may include causing one or more antenna probes 106 of the antenna array 104 to apply energy to the contents of the container 108, as shown in act 204 of FIG. 2. In some embodiments, the commodity monitoring system 114 may cause one or more antenna probes 106 of the antenna array 104 to apply energy to the contents of the container 108. For example, the commodity monitoring system 114 may cause one or more antenna probes 106 of the antenna array 104 to apply energy to the contents of the container 108 through the antenna controller 116. As a non-limiting example, the commodity monitoring system 114 may utilize the RF switch/MUX 120and the TCVR 122 of the antenna controller 116 to apply energy to the contents of the container 108 via the antenna array 104.

In some embodiments, causing one or more antenna probes 106 of the antenna array 104 to apply energy to the contents of the container 108 may include activating (e.g., exciting) the one or more antenna probes 106 of the antenna array 104 to emit energy into the contents of the container 108. In some embodiments, activating the one or more antenna probes of the antenna array 104 may include the one or more antenna probe 106 emitting (e.g., injecting) electromagnetic energy into the contents of the container 108. In some embodiments, the electromagnetic energy may include RF signals. Furthermore, the electromagnetic energy may be emitted at a set of (e.g., a plurality of) discrete, sequential frequencies. For instance, the electromagnetic energy may be emitted at a set of discrete, sequential frequencies ranging from about 0 MHz to about 100 MHz. As another non-limiting example, the electromagnetic energy may be emitted at a set of discrete, sequential frequencies ranging from 0 Hz to about 10 Hz. In some embodiments, the electromagnetic energy may be emitted as pulses (e.g., as short sequential bursts of energy). In some embodiments, the energy emitted into the contents of the container 108 may include one or more of, for example, voltages, currents, acoustic waves, x-rays, or any other type of energy conventionally used in imaging volumes. As a non-limiting example, the one or more antenna probes 106 of the antenna array 104 may apply (e.g., inject) RF signals (e.g., RF voltage signals) into the contents of the container 108.

In some embodiments, causing one or more the antenna array 104 to apply energy to the contents of the container 108 may include causing the antenna array 104 to apply energy via the antenna probes 106 one at a time. In some embodiments, the antenna array 104 may apply energy to the contents of the container 108 one antenna probe 106 at a time in succession around a perimeter (e.g., circumference) of the container 108. In some embodiments, the antenna array 104 may apply energy to the contents of the container 108 one antenna probe 106 at a time in a general helix pattern around a perimeter (e.g., circumference) of the container 108. In one or more embodiments, the antenna array 104 may apply energy to the contents of the container 108 starting with a lowermost antenna probe 106 by elevation and ending with an uppermost antenna probe 106.

In one or more embodiments, causing one or more the antenna array 104 to apply energy to the contents of the container 108 may include causing antenna array 104 to apply energy via the antenna probes 106 in pairs. In some embodiments, the antenna probes 106 of each pair may be directly adjacent to each other in either a horizontal direction or a vertical direction. In additional embodiments, the antenna probes 106 of each pair of antenna probes 106 may have one or more antenna probes 106 interposed between the antenna probes 106 of a given pair.

The method 200 may further include causing energy to be received by one or more antenna probes 106 of the antenna array 104, as shown in act 206 of FIG. 2. In some embodiments, the commodity monitoring system 114 may cause one or more antenna probes 106 of the antenna array 104 to receive energy from the contents of the container 108. For example, the commodity monitoring system 114 may utilize the antenna controller 116 to cause one or more antenna probes 106 of the antenna array 104 to receive energy from the contents of the container 108 through the antenna controller 116. As a non-limiting example, the commodity monitoring system 114 may utilize the RF switch/MUX 120and the TCVR 122 of the antenna controller 116 to receive energy from the contents of the container 108 via the antenna array 104.

In some embodiments, the energy received by the one or more antenna probes 106 of the antenna array 104 may include remaining (e.g., residual) energy after the injected energy has passed through at least portion the contents of the container 108. For example, the energy received by the one or more antenna probes 106 of the antenna array 104 may include energy scattered by the contents of the container 108. As a non-limiting example, the energy received by the one or more antenna probes 106 of the antenna array 104 may include RF signals (e.g., RF voltage signals) scattered by the contents of the container 108. In additional embodiments, the energy received by the one or more antenna probes 106 of the antenna array 104 may include one or more of voltages, currents, acoustic waves, x-rays, or any other type of energy conventionally used in imaging.

In one or more embodiments, the method 200 may include repeating act 204 and act 206 any number of times to achieve a measurement of the contents within the container 108. Furthermore, the method 200 may include alternating between act 204 and act 206. For instance, the method 200 may include injecting energy with a first antenna probe and receiving energy with one or more antenna probes, injecting energy with a second, different antenna probe and receiving energy with one or more antenna probes, injecting energy with a third, different antenna probe and receiving energy with one or more antenna probes, etc.

Responsive to receiving the energy via the one or more antenna probes 106 of the antenna array 104, the method 200 may include determining measurement data from received energy, as shown in act 208 of FIG. 2. In some embodiments, the commodity monitoring system 114 may determine the measurement data from the received energy. In one or more embodiments, the commodity monitoring system 114 may determine S-parameter measurements from the received energy. For example, the method 200 may include determining S-parameter measurements based on the received energy via known methods. In one or more embodiments, the S-parameter measurements may include ratios of voltage levels due to the decay between sending and receiving signals. For example, the ratios of voltage levels may include ratios of output voltages (e.g., voltages received by the antenna probes 106) relative to input voltages. In some embodiments, the determined S-parameter measurements may include magnitude (i.e., phaseless) data. In view of the foregoing, act 208 may include determining measurement data via any of the manners described in U.S. Pat. No. 11,125,796 B2, to Gilmore et al., issued Sep. 21, 2021, WO 2021/001796 A1, to Jeffrey et al., filed Jul. 3, 2020, WO 2021/070101 A1, to Jeffrey et al., filed Oct. 8, 2020, WO 2022/200909 A1, to Asefi et al., filed Mar. 14, 2022, WO 2022/200931 A1, to Lovetri et al., filed Mar. 16, 2022, and/or WO 2022/200932 A1, to Asefi et al., filed Mar. 16, 2022.

In additional embodiments, the method 200 may include determining additional and/or other representations of measurements of signal decay. For example, the method 200 may include measuring power directly without consideration of phase measurements and/or utilizing various known transforms to convert the determined S-parameter measurements into one or more of transmission parameters, impedance parameters, or admittance parameters. In one or more embodiments, the method 200 may include calibrating the determine measurement data. For example, the method 200 may include calibrating the determined measurement data via any of the manners described in, for example, U.S. Pat. No. 11,125,796 B2, to Gilmore et al., issued Sep. 21, 2021, WO 2021/001796 A1, to Jeffrey et al., filed Jul. 3, 2020, WO 2021/070101 A1, to Jeffrey et al., filed Oct. 8, 2020, WO 2022/200909 A1, to Asefi et al., filed Mar. 14, 2022, WO 2022/200931 A1, to Lovetri et al., filed Mar. 16, 2022, and/or WO 2022/200932 A1, to Asefi et al., filed Mar. 16, 2022.

Responsive to determining the measurement data from the received energy, the method 200 may include comparing the determined measurement data to reference measurement data of a known state of an antenna probe 106, as shown in act 210 of FIG. 2. For example, for each antenna probe 106 of the antenna array 104, the commodity monitoring system 114 may compare the determined measurement data for a given antenna probe 106 to reference measurement data of a known state of the given antenna probe 106. As used herein, the term “state,” when referring to the antenna probes 106 of the antenna array 104, may refer to whether the antenna probe 106 is “in commodity” (e.g., in contact with the commodity (e.g., the contents) within the container) or “out of commodity” (e.g., not in contact with the commodity within the container 108). Additionally, the reference measurement data may include measurement data acquired and determined for a given antenna probe 106 when the state of the given antenna probe 106 is known (e.g., in commodity or out of commodity). Accordingly, the commodity monitoring system 114 may compare the determined measurement data for a given antenna probe 106 to reference measurement data reflecting a known state of the given antenna probe 106. In some embodiments, the reference measurement data reflects that the given antenna probe 106 when in commodity (e.g., in grain). In additional embodiments, the reference measurement data reflects the given antenna probe 106 when out of commodity (e.g., out of grain).

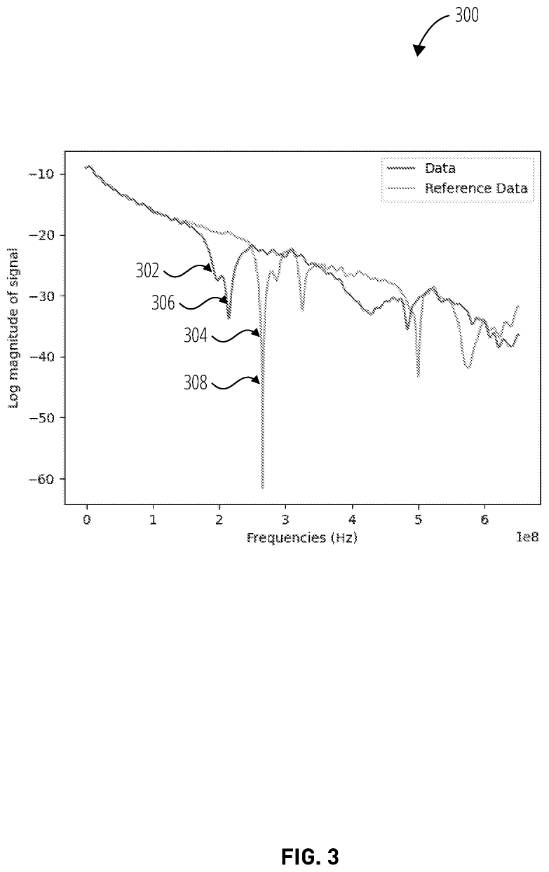

FIG. 3 shows a graph 300 showing an example comparison of determined measurement data 302 and reference measurement data 304 for a given antenna probe 106. In FIG. 3, the magnitude of determined S-parameters for the determined measurement data 302 and the reference measurement data 304 is shown in logarithmic form across a range of applied RF signal frequencies. In the example shown in FIG. 3, the reference measurement data 304 reflects an out of commodity state for the given antenna probe 106.

Referring to FIG. 1 through FIG. 3 together, in some embodiments, comparing determined measurement data to reference measurement data of a known state of an antenna probe 106 may include comparing curves representing the determined measurement data 302 and the reference measurement data 304. In particular, portions of curves defining dips 306, 308 in determined measurement data 302 and the reference measurement data 304 may be compared. Specifically, in general terms, the act 210 may include comparing the depths, the widths, and the slopes of correlating dips 306, 308 reflected in the curves of the determined measurement data 302 and the reference measurement data 304. Additionally, the method 200 may include comparing the frequency ranges spanned by correlating dips 306, 308 of the curves of the determined measurement data 302 and the reference measurement data 304.

As used herein, a “depth” of a given dip (e.g., dip 306) may refer to an overall amount of change in magnitude for a given dip from an uppermost magnitude included in the given dip relative to a lowermost magnitude included in the given dip. In some embodiments, an uppermost magnitude of the given dip may be determined when the curve reflecting the dip achieves a selected rate of change (e.g., slope). In some embodiments, the depth of the given dip may be determined relative to a fitted curve for the respective measurement data. As used herein, a “width” of a given dip (e.g., dip 306) may refer to a frequency range spanned by the given dip. In some embodiments, the frequency range may be estimated. As used herein, a “slope” of a side of a given dip (e.g., dip 306) (e.g., portions of the curve defining the sidewalls of dip) may refer to a rate at which the magnitude changes within a decline portion and an incline portion of the given dip. Additionally, a given dip 306 of the determined measurement data 302 may correlate to a given dip 306 of the reference measurement data 304 when the dips 306, 308 occur at frequency ranges that are relatively close to each other.

As noted above, act 210 may include comparing depths of correlating dips 306, 308 between the determined measurement data 302 and the reference measurement data 304. In some embodiments, comparing the depths of correlating dips 306, 308 of the determined measurement data 302 and the reference measurement data 304 may include determining an amount by which the depth of the dip 306 of the determined measurement data 302 changed (e.g., increased or decreased) from the depth of the correlating dip 308 of the reference measurement data 304. In some embodiments, a percentage by which the depth of the dip 306 of the determined measurement data 302 changed (e.g., increased or decreased) relative to the depth of the correlating dip 308 of the reference measurement data 304 may be determined.

In embodiments where the reference measurement data 304 reflects a given antenna probe 106 out of commodity, when the depth of the dip 306 of the determined measurement data 302 has decreased relative to the depth of the correlating dip 308 of the reference measurement data 304, the decrease can indicate that the given antenna probe 106 is now in commodity. In some embodiments, when the depth of the dip 306 of the determined measurement data 302 has decreased by at least a threshold percentage relative to the depth of the correlating dip 308 of the reference measurement data 304, the decrease can indicate that the given antenna probe 106 is now in commodity. In some embodiments, the threshold percentage may be at least about 50%, about 60%, about 70%, about 80%, or more.

In embodiments where the reference measurement data 304 reflects a given antenna probe 106 in commodity, when the depth of the dip 306 of the determined measurement data 302 has increased relative to the depth of the correlating dip 308 of the reference measurement data 304, the increase can indicate that the given antenna probe 106 is now out of commodity. In some embodiments, when the depth of the dip 306 of the determined measurement data 302 has increased by at least a threshold percentage relative to the depth of the correlating dip 308 of the reference measurement data 304, the increase can indicate that the given antenna probe 106 is now in commodity. In some embodiments, the threshold percentage may be at least about 150%, about 175%, about 200%, about 250%, or more.

As mentioned above, act 210 may include comparing widths of correlating dips 306, 308 between the determined measurement data 302 and the reference measurement data 304. In some embodiments, comparing the widths of correlating dips 306, 308 of the determined measurement data 302 and the reference measurement data 304 may include determining an amount by which the width of the dip 306 of the determined measurement data 302 changed (e.g., increased or decreased) from the width of the correlating dip 308 of the reference measurement data 304. In some embodiments, a percentage by which the width of the dip 306 of the determined measurement data 302 changed (e.g., increased or decreased) relative to the width of the correlating dip 308 of the reference measurement data 304 may be determined.

In embodiments where the reference measurement data 304 reflects a given antenna probe 106 out of commodity, when the width of the dip 306 of the determined measurement data 302 has increased relative to the width of the correlating dip 308 of the reference measurement data 304, the increase can indicate that the given antenna probe 106 is now in commodity. In some embodiments, when the width of the dip 306 of the determined measurement data 302 has increased by at least a threshold percentage relative to the depth of the correlating dip 308 of the reference measurement data 304, the increase can indicate that the given antenna probe 106 is now in commodity. In some embodiments, the threshold percentage may be at least about 50%, about 60%, about 75%, about 100%, or more.

In embodiments where the reference measurement data 304 reflects a given antenna probe 106 in commodity, when the width of the dip 306 of the determined measurement data 302 has decreased relative to the width of the correlating dip 308 of the reference measurement data 304, the decrease can indicate that the given antenna probe 106 is now out of commodity. In some embodiments, when the width of the dip 306 of the determined measurement data 302 has decreased by at least a threshold percentage relative to the width of the correlating dip 308 of the reference measurement data 304, the decrease can indicate that the given antenna probe 106 is now in commodity. In some embodiments, the threshold percentage may be at least about 25%, about 30%, about 40%, about 50%, or more.

As also noted above, act 210 may include comparing slopes of the portions of the curves defining (referred to herein after for simplicity as “comparing slopes of”) correlating dips 306, 308 between the determined measurement data 302 and the reference measurement data 304. In some embodiments, comparing the slopes of correlating dips 306, 308 of the determined measurement data 302 and the reference measurement data 304 may include determining an amount by which the slopes (e.g., a decline slope and an incline slope) of the dip 306 of the determined measurement data 302 changed (e.g., increased or decreased) from the slopes (e.g., a decline slope and an incline slope) of the correlating dip 308 of the reference measurement data 304. In some embodiments, a percentage by which the slopes (e.g., a decline slope and an incline slope) of the dip 306 of the determined measurement data 302 changed (e.g., increased or decreased) relative to the slopes (e.g., a decline slope and an incline slope) of the correlating dip 308 of the reference measurement data 304 may be determined.

In embodiments where the reference measurement data 304 reflects a given antenna probe 106 out of commodity, when the steepness of the slopes of the dip 306 of the determined measurement data 302 has decreased relative to the steepness of the slopes of the correlating dip 308 of the reference measurement data 304, the decrease can indicate that the given antenna probe 106 is now in commodity.

In embodiments where the reference measurement data 304 reflects a given antenna probe 106 in commodity, when the steepness of the slopes of the dip 306 of the determined measurement data 302 has increased relative to the steepness of the slopes of the correlating dip 308 of the reference measurement data 304, the increase can indicate that the given antenna probe 106 is now out of commodity.

As also mentioned above, act 210 may also include comparing frequency ranges spanned by correlating dips 306, 308 between the determined measurement data 302 and the reference measurement data 304. In some embodiments, comparing the frequency ranges of correlating dips 306, 308 of the determined measurement data 302 and the reference measurement data 304 may include comparing where a center point (i.e., a central frequency) of the frequency range spanned by the dip 306 of the determined measurement data 302 and a center point (i.e., a central frequency) of the frequency range spanned by the correlating dip 308 of the reference measurement data 304 fall along the X-axis (i.e., the frequency axis). In some embodiments, the central frequency changing by a threshold percentage between correlating dips 306, 308 may indicate that the given antenna has changed to either in commodity or out of commodity depending on a prior state of the given antenna. In one or more embodiments, the threshold percentage may be within a range of about 3% to about 15%. In additional embodiments, the threshold percentage may be within a range of about 3% to about 10%. In further embodiments, the threshold percentage may be within a range of about 3% to about 7%. For example, the threshold percentage may be about 4%.

In embodiments where the reference measurement data 304 reflects a given antenna probe 106 out of commodity, when the dip 306 of the determined measurement data 302 spans lower frequencies (i.e., the central frequency is lower) relative to the correlating dip 308 of the reference measurement data 304, the lower frequencies can indicate that the given antenna probe 106 is now in commodity.

In embodiments where the reference measurement data 304 reflects a given antenna probe 106 in commodity, when the dip 306 of the determined measurement data 302 spans higher frequencies (i.e., the central frequency is higher) relative to the correlating dip 308 of the reference measurement data 304, the higher frequencies can indicate that the given antenna probe 106 is now out of commodity.

. Referring still to FIG. 2 and FIG. 3 together, in some embodiments, comparing the determined measurement data to the reference measurement data of a known state of an antenna probe 106 may include comparing the depth, width, slopes, and frequencies ranges of only a first dip 306, 308 of each curve reflected by the determined measurement data to the reference measurement data. For example, the comparison may only consider the dip 306, 308 of each curve that occurs at the lowest frequencies (e.g., a leftmost dip of each curve within the view depicted in FIG. 3). In additional embodiments, each dip within each curve may be considered in the comparison.

In some embodiments, comparing the determined measurement data to the reference measurement data of a known state of an antenna probe 106 may include acquiring measurement data from the antenna probes 106 at a plurality of instances over a period of time and comparing the measurement data acquired at the plurality of instances. Put another way, comparing the determined measurement data to the reference measurement data of a known state of an antenna probe 106 may include monitoring measurement data acquired via the antenna probes 106 over time.

Referring to FIG. 1 through FIG. 3 together, responsive to comparing the determined measurement data to the reference measurement data of a known state of an antenna probe 106, the method 200 may include determining a state of each antenna probe 106 of the antenna array 104, as shown in act 212 of FIG. 2. For example, act 212 may include performing any of the comparisons described above in regard to act 210. Furthermore, the commodity monitoring system 114 may determine the state of each antenna probe 106 of the antenna array 104. In particular, based on reference measurement data 304 of each antenna probe 106 of the antenna array 104, act 212 may include determining, for each antenna probe 106, whether the antenna probe 106 is in commodity or out of commodity.

Moreover, based on the determined state of each of the antenna probes 106 of the antenna array 104, the method 200 may include determining a height of the contents against the inner surface of the wall of the container 108 at one or more regions of the container 108, as shown in act 214 of FIG. 2. In particular, the commodity monitoring system 114 may determine a height of the contents against the inner surface of the wall of the container 108. In some embodiments, by determining, for each antenna probe 106 of the antenna array 104, whether the antenna probe 106 is in commodity or out of commodity and based on known elevations (e.g., vertical locations) and known locations of the antenna probes 106 of the antenna array 104 along a perimeter (e.g., circumference) of the container 108, the commodity monitoring system 114 may determine a height of the contents against the inner surface of the wall of the container 108 at one or more regions of the container 108.

In some embodiments, determining a height of the contents against the inner surface of the wall of the container 108 at one or more regions of the container 108 may include determining the height of the contents based at least partially on a known time period since acquiring given measurement data. For example, determining a height of the contents against the inner surface of the wall of the container 108 at one or more regions of the container 108 may include estimating how much the height of the contents has changed relative to an elevation of an antenna probe 106, previously determined to be within commodity, based at least partially on one or more of 1) a known time period since acquiring measurement data indicating the antenna probe 106 is in commodity, 2) a known amount of commodity (e.g., grain) added to the container 108, 3) a known amount of commodity (e.g., grain) removed from the container 108, and/or 4) a known rate at which the height of the contents has changed previously.

In one or more embodiments, determining a height of the contents against the inner surface of the wall of the container 108 at one or more regions of the container 108 may include estimating a profile of the height of the contents on the inner surface of the wall of the container 108.

Additionally, the method 200 may include outputting determined heights of the contents against the inner surface of the wall of the container 108 at one or more regions of the container 108 to the client device 112. For example, the commodity monitoring system 114 may cause the determined heights of the contents against the inner surface of the wall of the container 108 at one or more regions of the container 108 to be displayed on the client devices. Additionally, the method 200 may include outputting the determined heights to one or more third party systems.

Referring to FIG. 1 and FIG. 2 together, the method 200 may optionally include adjusting operation of the antenna array 104, as shown in act 216 of FIG. 2. For example, based on a determination of which antenna probes 106 are in commodity and which antenna probes 106 are out of commodity, the commodity monitoring system 114 may deactivate some antenna probes 106 or may change frequencies of signals output (e.g., applied) by one or more antenna probes 106 of the antenna array 104.

FIG. 4 is a schematic view of a computer device 414. In some embodiments, one or more of the antenna controller 116, the client device 112, or the server 110 may include a computer device such as the computer device 414 of FIG. 4. The computer device 414 may include a communication interface 402, a processor 404, a memory 406, a storage device 408, an input/output device 410, and a bus 412.

In some embodiments, the processor 404 includes hardware for executing instructions, such as those making up a computer program. As an example, and not by way of limitation, to execute instructions, the processor 404 may retrieve (or fetch) the instructions from an internal register, an internal cache, the memory 406, or the storage device 408 and decode and execute them. In some embodiments, the processor 404 may include one or more internal caches for data, instructions, or addresses. As an example, and not by way of limitation, the processor 404 may include one or more instruction caches, one or more data caches, and one or more translation look aside buffers (TLBs). Instructions in the instruction caches may be copies of instructions in the memory 406 or the storage device 408.

The memory 406 may be coupled to the processor 404. The memory 406 may be used for storing data, metadata, and programs for execution by the processor(s). The memory 406 may include one or more of volatile and non-volatile memories, such as Random-Access Memory (“RAM”), Read-Only Memory (“ROM”), a solid state disk (“SSD”), Flash, Phase Change Memory (“PCM”), or other types of data storage. The memory 406 may be internal or distributed memory.

The storage device 408 may include storage for storing data or instructions. As an example, and not by way of limitation, storage device 408 can comprise a non-transitory storage medium described above. The storage device 408 may include a hard disk drive (HDD), Flash memory, an optical disc, a magneto-optical disc, magnetic tape, or a Universal Serial Bus (USB) drive or a combination of two or more of these. The storage device 408 may include removable or non-removable (or fixed) media, where appropriate. The storage device 408 may be internal or external to the computing storage device 408. In one or more embodiments, the storage device 408 is non-volatile, solid-state memory. In other embodiments, the storage device 408 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or Flash memory or a combination of two or more of these.

The input/output device 410 may allow an operator of the commodity monitoring system 114 to provide input to, receive output from, and otherwise transfer data to and receive data from computer device 414. The input/output device 410 may include a mouse, a keypad or a keyboard, a joystick, a touch screen, a camera, an optical scanner, network interface, modem, other known I/O devices, or a combination of such I/O interfaces. The input/output device 410 may include one or more devices for presenting output to an operator, including, but not limited to, a graphics engine, a display (e.g., a display screen), one or more output drivers (e.g., display drivers), one or more audio speakers, and one or more audio drivers. In certain embodiments, the input/output device 410 is configured to provide graphical data to a display for presentation to an operator. The graphical data may be representative of one or more graphical user interfaces and/or any other graphical content as may serve a particular implementation. As is described above, the computer device 414 and the input/output device 410 may be utilized to display data (e.g., images and/or video data) regarding the contents of the container 108.

The communication interface 402 can include hardware, software, or both. The communication interface 402 may provide one or more interfaces for communication (such as, for example, packet-based communication) between the computer device 414 and one or more other computing devices or networks (e.g., a server). As an example, and not by way of limitation, the communication interface 402 may include a network interface controller (NIC) or network adapter for communicating with an Ethernet or other wire-based network or a wireless NIC (WNIC) or wireless adapter for communicating with a wireless network, such as a WI-FI.

In some embodiments, the bus 412 (e.g., a Controller Area Network (CAN) bus) may include hardware, software, or both that couples components of computer device 414 to each other and to external components.

All references cited herein are incorporated herein in their entireties. If there is a conflict between definitions herein and in an incorporated reference, the definition herein shall control.

The embodiments of the disclosure described above and illustrated in the accompanying drawings do not limit the scope of the disclosure, which is encompassed by the scope of the appended claims and their legal equivalents. Any equivalent embodiments are within the scope of this disclosure. Indeed, various modifications of the disclosure, in addition to those shown and described herein, such as alternate useful combinations of the elements described, will become apparent to those skilled in the art from the description. Such modifications and embodiments also fall within the scope of the appended claims and equivalents.

What is claimed is:

1. A commodity monitoring system comprising:
at least one processor; and
at least one non-transitory computer-readable storage medium storing instructions thereon that, when executed by the at least one processor, cause the commodity monitoring system to:
receive measurement data from an antenna probe of an antenna array mounted within a container;
compare the received measurement data to reference measurement data of a known state of the antenna probe of the antenna array; and
based at least partially on the comparison, determine whether the antenna probe of the antenna array is in a commodity within the container or out of the commodity within the container.

2. The commodity monitoring system of claim 1, further comprising instructions that when executed by the at least one processor, cause the commodity monitoring system to, based at least partially on the determination whether the antenna probe of the antenna array is in the commodity within the container or out of the commodity within the container, determine a height of the commodity against an inner surface of a wall of the container within a least one region of the container.

3. The commodity monitoring system of claim 1 or 2, further comprising instructions that when executed by the at least one processor, cause the commodity monitoring system to:
receive measurement data from each antenna probe of the antenna array;
compare the received measurement data of each antenna probe to reference measurement data of a known state of each antenna probe of the antenna array; and
based at least partially on the comparisons, determine whether each antenna probe of the antenna array is in the commodity within the container or out of the commodity within the container.

4. The commodity monitoring system of claim 3, further comprising instructions that when executed by the at least one processor, cause the commodity monitoring system to, based at least partially on the determinations whether each antenna probe of the antenna array is in the commodity within the container or out of the commodity within the container, determine heights of the commodity against an inner surface of a wall of the container within at least a plurality of regions of the container.

5. The commodity monitoring system of claim 4, further comprising instructions that when executed by the at least one processor, cause the commodity monitoring system to estimate a profile of the height of the commodity against the inner surface of the wall of the container.

6. The commodity monitoring system of claim 4 or 5, further comprising instructions that when executed by the at least one processor, cause the commodity monitoring system to provide the determined heights of the commodity against the inner surface of the wall of the container to a client device for display.

7. The commodity monitoring system of any one of claims 1 to 6, further comprising instructions that when executed by the at least one processor, cause the commodity monitoring system to:
cause the antenna probe of the antenna array to apply an energy to the commodity within the container; and
receive remaining energy that has passed through at least a portion of the commodity via at least one other antenna probe of the antenna array.

8. The commodity monitoring system of claim 7, further comprising instructions that when executed by the at least one processor, cause the commodity monitoring system to determine the measurement data based at least partially on the received remaining energy.

9. The commodity monitoring system of claim 7 or 8, wherein causing the antenna probe of the antenna array to apply an energy to the commodity within the container comprising causing the antenna probe to apply RF signals to the commodity within the container.

10. The commodity monitoring system of any one of claims 1 to 9, wherein comparing the received measurement data to the reference measurement data of a known state of the antenna probe of the antenna array comprises comparing a first dip reflected in a plotted curve of the received measurement data across a range of frequencies to a correlating, second dip reflected in a plotted curve of the reference measurement data across the range of frequencies.

11. The commodity monitoring system of claim 10, wherein comparing the first dip to the correlating, second dip comprises comparing a central frequency of the first dip to a central frequency of the correlating, second dip.

12. The commodity monitoring system of any one of claims 1 to 11, wherein reference measurement data of a known state of the antenna probe of the antenna array reflects the antenna probe in commodity.

13. The commodity monitoring system of any one of claims 1 to 11, wherein reference measurement data of a known state of the antenna probe of the antenna array reflects the antenna probe out of commodity.

14. The commodity monitoring system of any one of claims 1 to 12, wherein the received measurement data comprises a magnitude of a received RF signal.

15. A method of monitoring a commodity within a container, the method comprising:
applying an energy to the commodity within the container via at least one antenna probe of an antenna array mounted within the container;
receiving remaining energy that has passed through at least a portion of the commodity or an interior of the container via at least one other antenna probe of the antenna array;
based on the received remaining energy, determining measurement data;
comparing the determined measurement data to reference measurement data of a known state of a given antenna probe of the antenna array; and
based at least partially on the comparison, determining whether the given antenna probe of the antenna array is in the commodity within the container or out of the commodity within the container.

16. The method of claim 15, further comprising:
based at least partially on the determination whether the given antenna probe of the antenna array is in the commodity within the container or out of the commodity within the container, determining a height of the commodity against an inner surface of a wall of the container within a least one region of the container.

17. The method of claim 16, further comprising:
estimating a profile of the height of the commodity against the inner surface of the wall of the container.

18. The method of any one of claims 15 to 17, wherein applying an energy to the commodity comprises emitting electromagnetic energy into the commodity a set of discrete, sequential frequencies.

19. The method of any one of claims 15 to 18, wherein comparing the determined measurement data to the reference measurement data comprises comparing a first dip reflected in a plotted curve of the received measurement data across a range of frequencies to a correlating, second dip reflected in a plotted curve of the reference measurement data across the range of frequencies.

20. A system comprising:
a container housing a commodity;
an antenna array having a plurality of antenna probes within the container;
an antenna controller operably coupled to and in communication with the antenna array;
a commodity monitoring system in communication with the antenna controller and comprising:
at least one processor; and
at least one non-transitory computer-readable storage medium storing instructions thereon that, when executed by the at least one processor, cause the commodity monitoring system to:
receive measurement data from the antenna array;
compare the received measurement data to reference measurement data of known states of the plurality of antenna probes of the antenna array; and
based at least partially on the comparison, determine whether a given antenna probe of the plurality of antenna probes of the antenna array is in the commodity within the container or out of the commodity within the container.
